(19) United States
(12) Patent Application Publication
(10) Pub. No.: US 2021/0328614 A1
(43) Pub. Date: Oct. 21, 2021

(54) Protective Cellphone Case With Integrated Display Apparatus

(71) Applicant: Kyle Shearer, Las Vegas, NV (US)

(72) Inventor: Kyle Shearer, Las Vegas, NV (US)

(21) Appl. No.: 16/854,386

(22) Filed: Apr. 21, 2020

(51) Int. Cl. H04B 1/3888; G06F 1/16

(52) U.S. Cl. CPC H04B 1/3888; G06F 1/1632; G06F 2200/1633; G06F 1/1656; G06F 1/1654

(57) ABSTRACT

A protective cellphone case with integrated display apparatus for protecting a cellphone and adding a rear display includes a case body having a case front side, a case back side, a case left side, a case right side, a case top side, and a case bottom side defining a case inside to secure a cellphone. The case front side has a main screen aperture. A display screen is coupled to an outer face of the case back side. A battery is coupled within the case body and is in operational communication with the display screen. A charging port is coupled to the case body and is in operational communication with the battery. A storage chip is coupled within the case body and is in operational communication with the display screen to show a saved image.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to cellphone case device and more particularly pertains to a new cellphone case device for protecting a cellphone and adding a rear display.

### (2) Description of Related Art Including Information Disclosed Under 37 CFR 1.97 and 1.98

The prior art relates to cellphone case devices and dual displays for cellphones. Existing cases provide varying degrees of protection and personalization, and external display options for cellphones are known. However, known devices do not incorporate a display directly into a protective case.

### BRIEF SUMMARY OF THE INVENTION

An embodiment of the disclosure meets the needs presented above by generally comprising a case body having a case front side, a case back side, a case left side, a case right side, a case top side, and a case bottom side defining a case inside configured to secure a cellphone. The case front side has a main screen aperture. A display screen is coupled to an outer face of the case back side. A battery is coupled within the case body and is in operational communication with the display screen. A charging port is coupled to the case body and is in operational communication with the battery. A storage chip is coupled within the case body and is in operational communication with the display screen to show a saved image.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric view of a protective cellphone case with integrated display apparatus according to an embodiment of the disclosure.

FIG. 2 is an isometric view of an embodiment of the disclosure.

FIG. 3 is a rear elevation view of an embodiment of the disclosure.

FIG. 4 is a cross-sectional view of an embodiment of the disclosure along the line 4-4 of FIG. 3.

FIG. 5 is an in-use view of an embodiment of the disclosure.

FIG. 6 is a block diagram view of an embodiment of the disclosure.

### DETAILED DESCRIPTION OF THE INVENTION

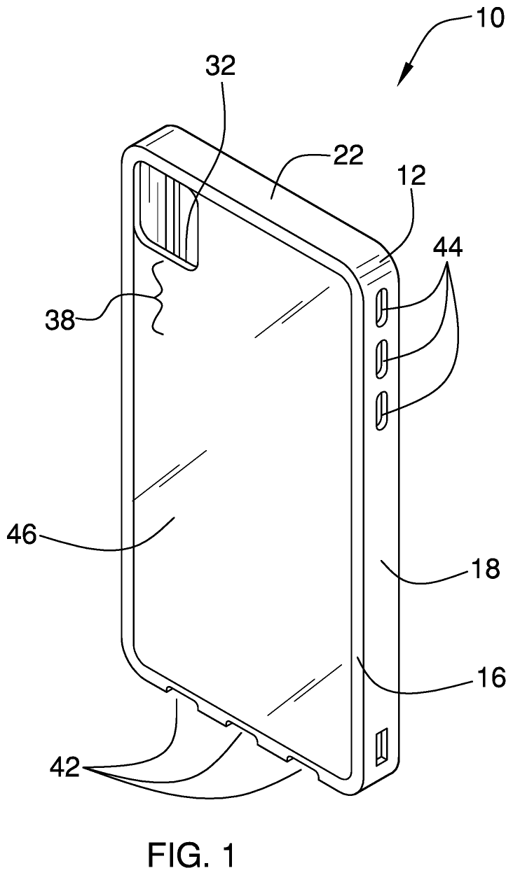

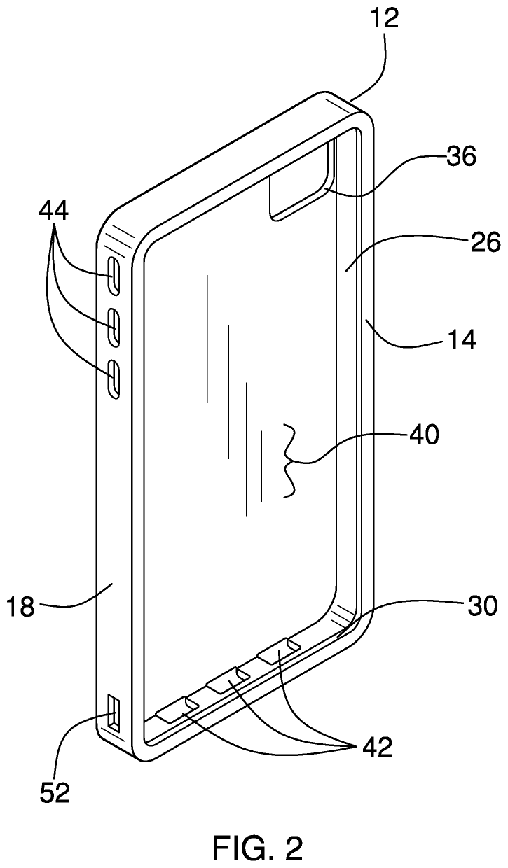

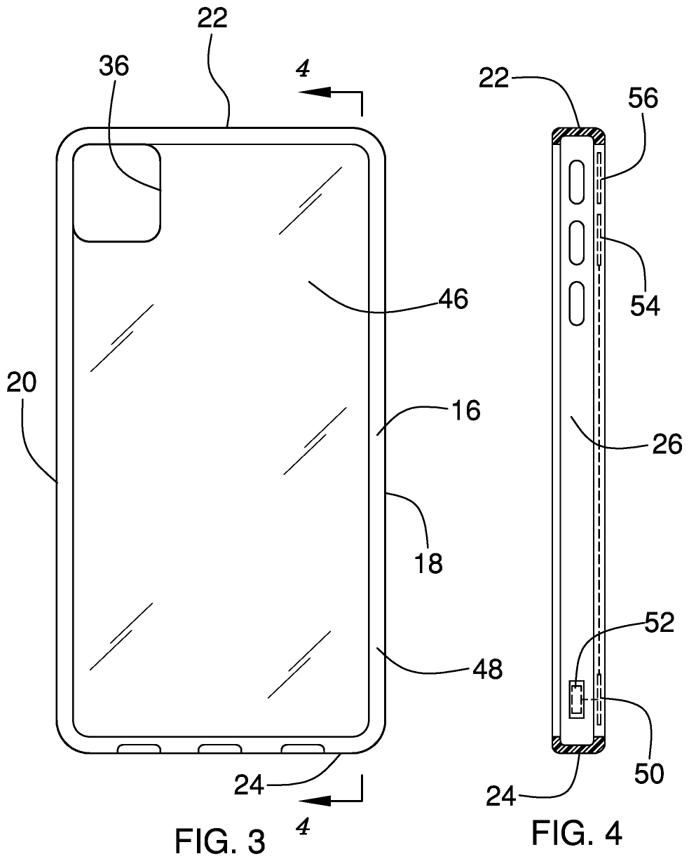

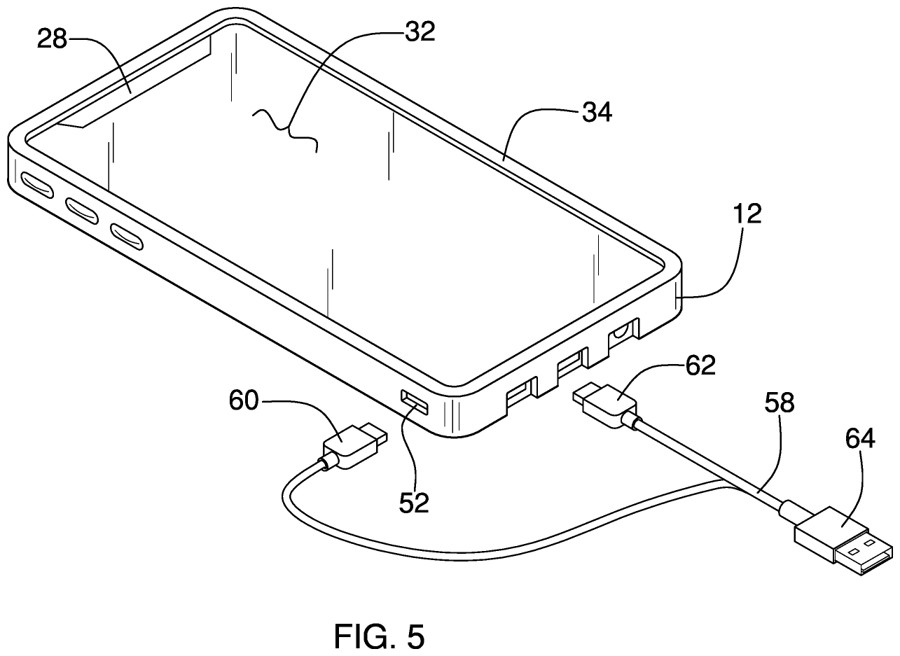

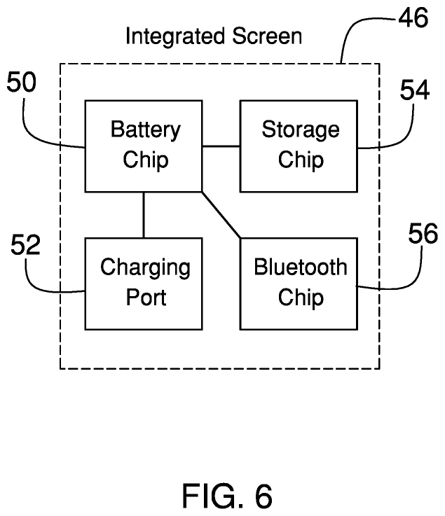

With reference now to the drawings, and in particular to FIGS. 1 through 6 thereof, a new cellphone case device embodying the principles and concepts of an embodiment of the disclosure and generally designated by the reference numeral 10 will be described.

As best illustrated in FIGS. 1 through 6, the protective cellphone case with integrated display apparatus 10 generally comprises a case body 12 having a case front side 14, a case back side 16, a case left side 18, a case right side 20, a case top side 22, and a case bottom side 24 defining a case inside 26 configured to secure a cellphone 28. The case front side 14 has a main screen aperture 30 to fully expose a principal display 32 of the cellphone. A front perimeter portion 34 of the case front side may be raised above the principal display 32 for improved protection.

The case backside 16 has a camera aperture 36 extending from an outer face 38 through an inner face 40 thereof and dimensioned to receive a camera lens of the cellphone 28. The case body 12 may include a plurality of feature apertures 42 extending through the case bottom side 24 and configured to expose features of the cellphone 28 such as speakers and ports. The plurality of feature apertures 42 may be three evenly spaced feature apertures 42. The case body 12 may include a plurality of control apertures 44 extending through the case left side 18 and the case right side 20. The plurality of control apertures 44 is configured to expose controls of the cellphone 28 such as volume buttons and power switches.

A display screen 46 is coupled to the outer face 38 of the case back side. The display screen 46 may occupy an entirety of the outer face 38 of the case back side excepting a back perimeter portion 48. The back perimeter portion 48 may be raised above the display screen 46 for improved protection.

A battery 50 is coupled within the case body 12 and in operational communication with the display screen 46. A charging port 52 is coupled to the case body 12 and in operational communication with the battery 50. A storage chip 54 is coupled within the case body 12 and is in operational communication with the display screen 46 to show a saved image. A Bluetooth chip 56 may be coupled within the case body 12. The Bluetooth chip 56 is in operational communication with the storage chip 54 and is configured to interface with the cellphone 28.

The apparatus 10 may include a split charging cable 58 having a first charge head 60, a second charge head 62, and an adaptor head 64. The first charge head 60 is selectively engageable with the charging port 52, the second charge head 62 is configured to selectively engage and charge the cellphone 28, and the adaptor head 64 is configured to selectively engage a power adaptor.

In use, the cellphone 28 is placed within the case inside 26 of the case body 12. The Bluetooth chip 56 is then used to operate the storage chip 54 through the cellphone 28 to control how the display screen 46 is used. Images and videos may be selected as background displays on the display screen 46 or set to display with calls, texts, and other notifications.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A protective cellphone case with integrated display apparatus comprising:
a case body having a case front side, a case back side, a case left side, a case right side, a case top side, and a case bottom side defining a case inside configured to secure a cellphone, the case front side having a main screen aperture;
a display screen coupled to the case body, the display screen being coupled to an outer face of the case back side, the display screen occupying an entirety of the outer face of the case back side excepting a back perimeter portion, the back perimeter portion being raised above the display screen wherein the display screen is inset relative to the back perimeter portion of the case back side;
a battery coupled within the case body, the battery being in operational communication with the display screen;
a charging port coupled to the case body, the charging port being in operational communication with the battery; and
a storage chip coupled within the case body, the storage chip being in operational communication with the display screen to show a saved image.

2. The protective cellphone case with integrated display apparatus of claim 1 further comprising a Bluetooth chip coupled within the case body, the Bluetooth chip being in operational communication with the storage chip and being configured to interface with the cellphone.

3. The protective cellphone case with integrated display apparatus of claim 1 further comprising the case backside having a camera aperture extending from the outer face through an inner face thereof.

4. (canceled)

5. (canceled)

6. The protective cellphone case with integrated display apparatus of claim 1 further comprising the case body having a plurality of feature apertures extending through the case bottom side, the plurality of feature apertures being configured to expose features of the cellphone such as speakers and ports.

7. The protective cellphone case with integrated display apparatus of claim 1 further comprising the case body having a plurality of control apertures extending through the case left side and the case right side, the plurality of control apertures being configured to expose controls of the cellphone such as volume buttons and power switches.

8. The protective cellphone case with integrated display apparatus of claim 1 further comprising a split charging cable, the split charging cable having a first charge head, a second charge head, and an adaptor head, the first charge head being selectively engageable with the charging port, the second charge head being configured to selectively engage the cellphone, and the adaptor head being configured to selectively engage a power adaptor.

9. A protective cellphone case with integrated display apparatus comprising:
a case body having a case front side, a case back side, a case left side, a case right side, a case top side, and a case bottom side defining a case inside configured to secure a cellphone, the case front side having a main screen aperture, the case backside having a camera aperture extending from an outer face through an inner face thereof, the case body having a plurality of feature apertures extending through the case bottom side, the plurality of feature apertures being configured to expose features of the cellphone such as speakers and ports, the case body having a plurality of control apertures extending through the case left side and the case right side, the plurality of control apertures being configured to expose controls of the cellphone such as volume buttons and power switches;
a display screen coupled to the case body, the display screen being coupled to the outer face of the case back side, the display screen occupying an entirety of the outer face of the case back side excepting a back perimeter portion, the back perimeter portion being raised above the display screen wherein the display screen is inset relative to the back perimeter portion of the case back side;
a battery coupled within the case body, the battery being in operational communication with the display screen;
a charging port coupled to the case body, the charging port being in operational communication with the battery;
a storage chip coupled within the case body, the storage chip being in operational communication with the display screen to show a saved image; and
a Bluetooth chip coupled within the case body, the Bluetooth chip being in operational communication with the storage chip and being configured to interface with the cellphone.

10. The protective cellphone case with integrated display apparatus of claim 9 further comprising a split charging cable, the split charging cable having a first charge head, a second charge head, and an adaptor head, the first charge head being selectively engageable with the charging port, the second charge head being configured to selectively engage the cellphone, and the adaptor head being configured to selectively engage a power adaptor.
